(19) United States
(12) Patent Application Publication
(10) Pub. No.: US 2008/0001542 A1
(43) Pub. Date: Jan. 3, 2008

(54) DIELECTRIC BARRIER DISCHARGE LAMPS WITH A PREFABRICATED STOPPER AND ASSOCIATED MANUFACTURING METHOD

(75) Inventors: Georg Bschorer, Herbrechtingen (DE); Jorg Rink, Syrgenstein (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/764,872

(22) Filed: Jun. 19, 2007

(30) Foreign Application Priority Data
Jun. 28, 2006 (DE) 10 2006 029 719.9

(51) Int. Cl. H01J 61/36; H01J 9/24

(52) U.S. Cl. 313/623; 445/26

(57) ABSTRACT

A dielectric barrier discharge lamp with a discharge vessel (6) having inner electrodes (7) and with a gas-impermeable stopper (10). The stopper (10) has power supply lines (2) making contact with the inner electrodes (7). The gas-impermeable stopper (10) is incorporated in the discharge vessel (6) as a cohesively handleable part, by it being introduced into an opening of the discharge vessel (6). In this case, the opening of the discharge vessel (6) is sealed in a gas-tight manner by the stopper (10) via a change in shape of the discharge vessel (6) and/or of the stopper (10).

### TECHNICAL FIELD

The present invention relates to a dielectric barrier discharge lamp with a gas-impermeable stopper, which has power supply lines making contact with the inner electrodes.

### PRIOR ART

Dielectric barrier discharge lamps are widespread and are known in various embodiments. The discharge vessels of the discharge lamps are often tubular, but flat discharge vessels are also known. In this case, for example, two rectangular discharge vessel walls lie opposite one another at a comparatively small distance from one another and are sealed off at their ends by a discharge vessel edge.

In dielectric barrier discharge lamps, so-called DBD lamps, the discharge medium in the interior of the discharge vessel is separated from the electrodes by a dielectric. Often the electrodes are in this case on the inside of the discharge vessel, and the dielectric is applied to these electrodes. The injection of power via the dielectrically impeded electrodes is in this case based on a radiofrequency displacement current within the dielectric.

Prior to their completion, the discharge vessels have at least one opening, via which the interior of the discharge vessel is cleaned and filled with a discharge medium. This can take place via a plate-shaped stopper which has been fused into the interior of the opening and has a gas-permeable exhaust tube, as disclosed, for example, in WO 02/27747.

In order then to be able to inject power into the inner electrodes, said inner electrodes can be guided along the discharge vessel in such a way that they run in the interface between the plate-shaped stopper and the discharge vessel. Contact can then be made between the electrodes and power supply lines outside of the stopper.

The abovementioned specification discloses that the exhaust tube of the plate and therefore the discharge vessel are fused off in a gas-tight manner in the case of the complete dielectric barrier discharge lamp.

### DESCRIPTION OF THE INVENTION

The present invention is based on the object of specifying a dielectric barrier discharge lamp which is improved with respect to the way in which contact is made with the electrodes.

The invention relates to a dielectric barrier discharge lamp with a discharge vessel having inner electrodes and having a gas-impermeable stopper, which stopper has power supply lines making contact with the inner electrodes, characterized in that the gas-impermeable stopper with the power supply lines is incorporated in the discharge vessel as a cohesively handleable part, by the stopper being introduced into an opening of the discharge vessel, and the opening being sealed in a gas-tight manner by the stopper owing to a change in shape of at least one of the discharge vessel and the stopper.

Preferred configurations of the invention are specified in the dependent claims and will be explained in more detail below. Furthermore, the description as a whole also relates to a method corresponding to the invention for manufacturing a dielectric barrier discharge lamp and also to a method for operating a correspondingly manufactured dielectric barrier discharge lamp, even if this is not explicitly specified in each case when the individual features are described.

As has already been briefly mentioned in connection with the explanation relating to the prior art, in order to manufacture a dielectric barrier discharge lamp an (or the) opening(s), via which the discharge vessel has been filled with the discharge medium, need(s) to be sealed in a gas-tight manner. Furthermore, contact needs to be made between the inner electrodes and the power supply lines.

The invention is based on the concept of sealing the opening of the discharge vessel and making contact with the inner electrodes by a prefabricated stopper which can be handled in a cohesive part and already has the power supply lines, the stopper itself in this case already being gas-impermeable, with the result that, in order to seal the opening, only the shape of the discharge vessel and/or that of the stopper needs to be changed.

A correspondingly designed dielectric barrier discharge lamp can be manufactured particularly efficiently. The prefabricated stopper which can be handled in one part can already be manufactured in advance independently of the discharge vessel and mounted. Even before it is introduced into the discharge vessel, the stopper has the power supply lines for injecting power into the electrodes. The power supply lines can be guided through the stopper, for example, or else attached to it. Since the stopper can be handled in one part, separate handling of the power supply lines and further stopper parts, for example a sintered glass body, when introducing the stopper into the opening of the discharge vessel is superfluous. Since the stopper itself is already gas-impermeable, it no longer needs to be sealed in a gas-tight manner after it has been introduced, as would be necessary, for example, in the case of an exhaust tube. The opening is then sealed in a gas-tight manner by the stopper.

For this purpose, for example, the discharge vessel wall can be heated, with the result that it attaches itself to the stopper. In addition, the stopper may also experience a change in shape, for example if the discharge vessel wall is pressed against or into the stopper (for example a stopper with glass) which may have been softened by heating. A change in shape of the stopper on its own can, however, also already seal the discharge lamp off in a gas-tight manner, for example if the stopper is introduced into the opening and, once the discharge vessel has been filled with the discharge medium, is pressed there into a tapering of the discharge vessel in the opening, the stopper or the corresponding part of the discharge vessel being softened. An additional seal, for example a cap, merely in order to seal off the discharge vessel, is neither necessary nor provided in accordance with the invention.

The stopper can be introduced into the opening of the discharge vessel in a variety of ways, for example by being plugged in or by being screwed in. In this case, it may be introduced in such a way that it seals off the opening of the discharge vessel flush. Such an arrangement is particularly robust.

Preferably, the introduced stopper overlaps the inner electrodes. In this case, the power supply lines run at least partially through the stopper, emerge from the stopper in the region of the overlap and make contact with the electrodes in the region of this overlap. In the case of a tubular discharge vessel having an approximately cylindrical stopper, for example two inner electrodes can be formed longitudinally along the tube, and the stopper can be introduced into the opening in such a way that part of its length overlaps the inner electrodes. In this case, the power supply lines may enter the stopper through the end side of said stopper, run through the stopper and emerge from it laterally again where the stopper overlaps the electrodes.

The inner electrodes of dielectric barrier discharge lamps, as has been mentioned briefly above, are coated with a dielectric. The dielectric may not be provided in the overlap between the stopper and the electrodes, but may also be provided. If the stopper also overlaps the dielectric shielding the electrodes from the discharge medium, this has a favorable effect on the field strength distribution in the surrounding environment of the stopper.

Preferably, once the discharge vessel has been sealed, part of one of the power supply lines is in electrically conductive contact with the discharge medium. In this way, the power supply line can at the same time act as an ignition aid for the discharge. The power supply line can be guided out of the stopper into the interior of the discharge vessel for this purpose, but the stopper may also have a cutout, through which the power supply line runs in such a way that it is in contact with the discharge medium.

In a preferred embodiment of the invention, the stopper has, in addition to the already provided power supply lines, an auxiliary ignition electrode, which, once the discharge vessel has been sealed, is in contact with the discharge medium. This additional auxiliary ignition electrode can be guided through the stopper and contact can be made with it itself; during operation it may be approximately at a steady-state potential predetermined by an electronic ballast. However, it may also be introduced into the stopper in such a way that it is electrically insulated by the stopper (with respect to the discharge lamp exterior). In this case, it may be a metallic object which is in contact with the discharge medium and is recessed on the inside of the stopper.

If the discharge vessel has two inner electrodes, the additional auxiliary ignition electrode can be located closer to one of the inner electrodes than to the other. In this way, the path lengths available for ionization for one polarity of the lamp is increased. With respect to the other polarity, the field strength is increased since the distance is smaller.

All of the illustrated ignition aids have a positive effect on the probability of the discharge being ignited owing to a field distortion brought about by them.

If, in the case of the stopper, a distinction is drawn between the stopper body and the power supply lines, it is an option to manufacture the stopper body as a sintered glass part. Sintered glass parts can be manufactured in a favorable manner and are extremely chemically stable and mechanically robust. If the discharge vessel first has a plurality of openings, for example two in each case end-side openings in the case of a tubular discharge vessel, it is an option to seal off one opening by a stopper according to the invention having a sintered glass body and to seal off the other opening(s) by a corresponding sintered glass body, but without power supply lines.

Preferably, in order to seal the opening in a gas-tight manner with the stopper, the discharge vessel wall is heated and attached to the stopper. During heating, the discharge vessel wall becomes soft; in the process, it may possibly already automatically attach itself to the introduced stopper. However, it is also possible to shape the softened discharge vessel wall actively in a corresponding manner, for example by exerting mechanical pressure. The discharge vessel does not need to be attached to the stopper along the entire depth of the stopper in the opening; it is possibly also sufficient for it to be attached along part of this depth.

If the ends of the power supply lines intended for making contact with the electrodes emerge laterally from the stopper and these ends are located in the overlap between the stopper and the inner electrodes (see above), this attachment can result in the electrically conductive contact being produced between the power supply lines and the electrodes.

In a preferred embodiment of the invention, the power supply lines emerge in a sprung manner from the stopper with their ends which are provided for making contact with the electrodes, before said stopper is introduced into the opening. If the stopper is introduced into the opening, the sprung ends of the power supply lines can then attach themselves to the electrodes in the overlap. In this way, a large contact area can be ensured between the power supply lines and the inner electrodes.

Alternatively or additionally, in a further preferred embodiment, the power supply lines can be anchored in the electrodes with their ends which are provided for making contact with the electrodes, by being provided with notches, even by a rotation of the stopper when it is introduced into the opening. In this way, a particularly intimate contact is produced between the power supply lines and the electrodes.

All of the abovementioned ways in which contact is made between the power supply lines and the inner electrodes can be protected effectively against external influences by the gas-tight closure according to the invention between the stopper and the discharge vessel. This is particularly advantageous in the automotive sector, in which the component parts need to be particularly robust with respect to environmental influences, such as moisture and temperature fluctuations, and with respect to corrosive environments.

Preferably, the stopper is introduced into the opening of the discharge vessel in such a way that there is a gas-permeable gap between the stopper and the discharge vessel wall, through which gap the discharge vessel can be filled with the discharge medium before the opening is sealed in a gas-tight manner or else other manufacturing steps can be carried out, such as evacuation and rinsing with a purification gas.

Preferably, the dielectric barrier discharge lamp according to the invention is operated in a lampholder, in which the stopper and/or the discharge vessel acts as the base, which therefore connects the power supply lines of the stopper to a power source, the power supply lines being guided into the lampholder supported merely by the stopper. An additional base arrangement, which embeds the discharge lamp in the lampholder, is therefore not necessary.

Preferably, in this case the lampholder, for the purpose of holding the discharge lamp, grips either the discharge vessel or the stopper or both.

The invention relates in principle to a method for manufacturing a dielectric barrier discharge lamp, which has a discharge vessel having inner electrodes and having a gas-impermeable stopper, which stopper has power supply lines making contact with the inner electrodes, having the following steps: manufacturing the gas-impermeable stopper with its power supply lines as a cohesively handleable part, introducing the stopper into an opening of the discharge vessel and sealing the opening in a gas-tight manner by the stopper owing to a change in shape of at least one of the discharge vessel and the stopper.

The invention also relates in principle to a method for operating a dielectric barrier discharge lamp manufactured according to the invention having the step of: introducing the discharge lamp into a lampholder, which connects the power supply lines of the stopper to a power source, the power supply lines being guided into the lampholder supported merely by the stopper.

### BRIEF DESCRIPTION OF THE DRAWINGS

The invention will be explained in more detail below with reference to the exemplary embodiments. The individual features disclosed in the process may also be essential to the invention in other combinations.

FIG. 1 shows a stopper for a dielectric barrier discharge lamp according to the invention.

FIG. 2 shows the stopper from FIG. 1 introduced into a discharge vessel of a discharge lamp according to the invention.

FIG. 3 shows how the stopper and the discharge vessel from FIG. 2 together form a gas-tight seal for the discharge lamp according to the invention.

FIG. 4 corresponds to FIG. 3 with an altered stopper.

FIG. 5 shows a further variation of FIG. 3.

FIG. 6 also shows a variation of FIG. 3.

FIG. 7a shows a variation of the stopper from FIG. 1, in plan view.

FIG. 7b shows a variation of the stopper from FIG. 1.

FIG. 8 shows a further variation of the stopper from FIG. 1, in plan view.

FIG. 9 shows the stopper from FIG. 1 introduced into a discharge vessel during an intermediate step in the manufacture of a discharge lamp according to the invention.

FIG. 10 shows a system according to the invention comprising a discharge lamp according to the invention and a lampholder suitable for said discharge lamp.

### PREFERRED EMBODIMENTS OF THE INVENTION

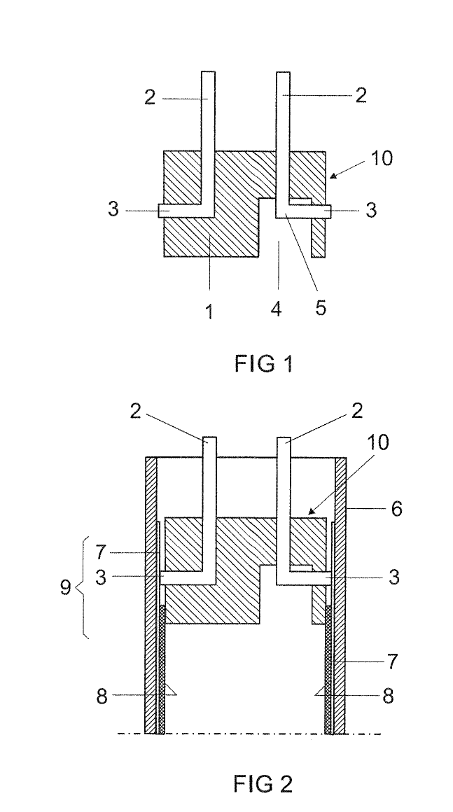

FIG. 1 shows a stopper 10. The stopper 10 has a sintered glass body 1 and power supply lines 2. The sintered glass body 1 is substantially cylindrical, apart from a cutout 4. The power supply lines 2 run into an end side of the cylindrical sintered glass body 1, partially through said sintered glass body and emerge laterally with their ends 3 again from the sintered glass body 1. The cutout 4 is introduced into the sintered glass body 1 in such a way that part 5 of one of the power supply lines 2 running through the sintered glass body 1 is exposed.

The power supply lines 2 and the sintered glass body 1 are intimately connected to one another in such a way that the stopper 10 itself is gas-impermeable and can be handled as a cohesive article in one part. The stopper 10 is prefabricated, with the result that it can in this case be introduced into a discharge vessel without any further changes.

FIG. 2 shows the stopper 10 from FIG. 1, introduced into one end of a tubular discharge vessel 6 consisting of glass. The discharge vessel has inner electrodes 7, which run along the length of the discharge vessel. The electrodes 7 are covered in the lower half of the figure by a dielectric 8, in this case a glass solder.

The stopper 10 from FIG. 1 is pushed into the opening shown of the discharge vessel 6. In this case, it overlaps the inner electrodes 7 in an overlap 9 and, to a lesser degree, the dielectric 8 covering the electrodes. The ends 3 of the power supply lines 2 are directed towards that part of the electrodes 7 which is exposed in the overlap 9. The stopper 10 has been inserted into the discharge vessel 6 so deeply that part of the discharge vessel wall still protrudes beyond the stopper.

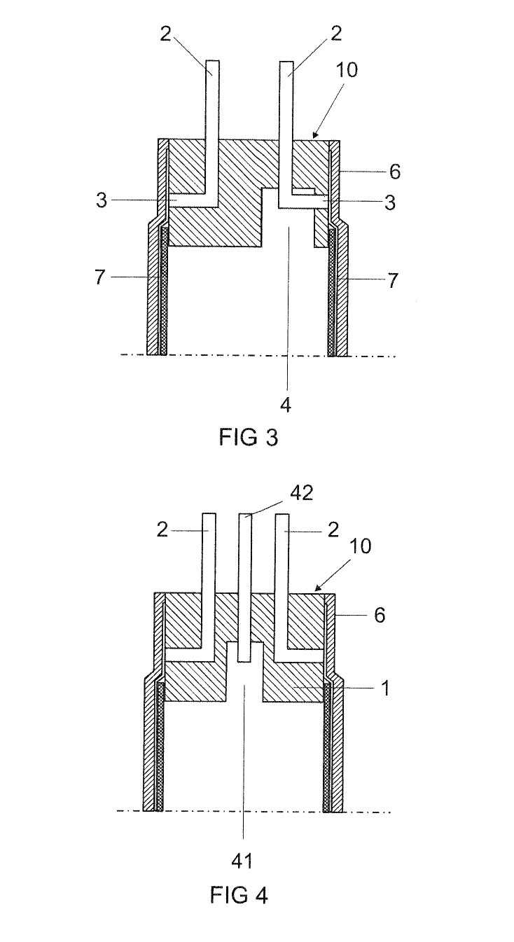

FIG. 3 shows the stopper 10 and the discharge vessel 6 from FIG. 2. In contrast to FIG. 2, the wall of the discharge vessel 6 is now attached to the stopper 10. For this purpose, the wall of the discharge vessel 6 has been heated and pressed against the stopper 10 by a roller. The wall of the discharge vessel 6 in this case attaches itself to the stopper 10 in such a way that the ends 3 of the power supply lines 2 are in electrically conductive contact with the electrodes 7.

The end side of the stopper 10 now ends flush with the end of the discharge vessel 6, in contrast to FIG. 2. For this purpose, the discharge vessel 6 has correspondingly been detached, after the heating.

FIG. 4 shows a variation of the discharge lamp vessel end from FIG. 3.

In contrast to FIGS. 1-3, the stopper 10 in this case has an additional electrically conductive auxiliary ignition electrode 42. The auxiliary ignition electrode 42 is guided through the end side of the stopper 10, as are the power supply lines 2, but is guided straight through said stopper and emerges again from the sintered glass body 1 on that side of the stopper 10 which faces the discharge medium in a cutout 41 positioned in the center. The auxiliary ignition electrode 42 is in the form of a plug-type contact, as is the power supply line 2, at its end lying outside of the discharge vessel 6. During operation, the auxiliary ignition electrode 42 is electrically conductively connected to an electronic ballast (not shown) and is permanently at a steady-state potential predetermined by the electronic ballast.

Precisely as in the case of the power supply lines, the field distortion caused by the auxiliary ignition electrode 42 results in the ignition of the discharge being facilitated.

In FIG. 5, in contrast to FIG. 4, no auxiliary ignition electrode 42 with which contact has been made is introduced in the sintered glass body 1, but a metallic ignition aid 43 with which no contact has been made is introduced. This takes place on that side of the sintered glass body 1 which faces the interior. In this case, contact cannot be made with the ignition aid 43 from the outside; it is at an undefined potential. In exactly the same way as the auxiliary ignition electrode 42, the ignition aid 43 facilitates ignition of the discharge owing to a field distortion caused by its presence.

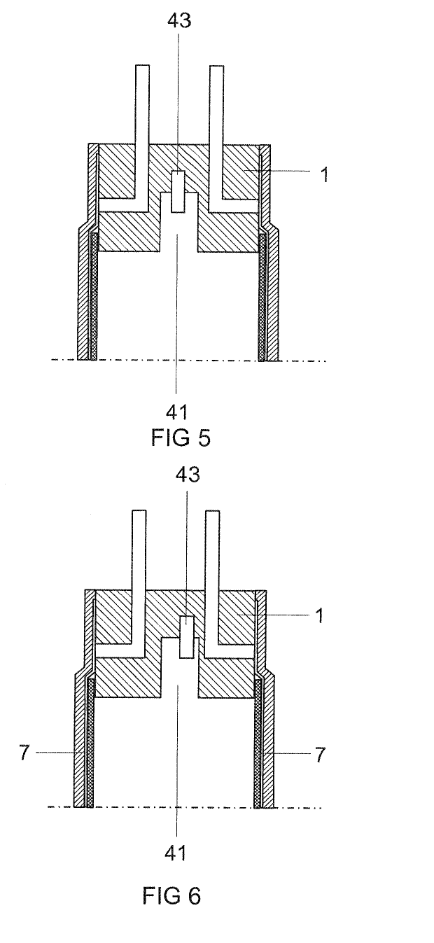

The end of a discharge lamp shown in FIG. 6 largely corresponds to the ends shown in FIGS. 3-5. In contrast to FIG. 5, the ignition aid 43 is now no longer attached centrally to the inner side of the sintered glass body 1, but is displaced in the direction of one of the two inner electrodes 7. As a result, the path which charged particles can use in order to ionize further molecules of the discharge medium for one polarity of the discharge lamp is enlarged. This also assists the ignition of the discharge.

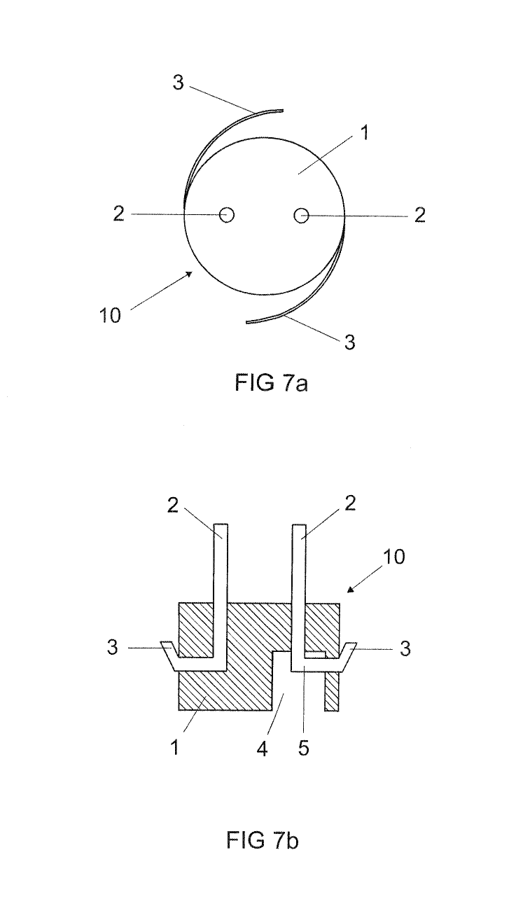

FIG. 7a shows a stopper 10 with a sintered glass body as in FIG. 1, but in a plan view, and power supply lines 2, which are formed at the end and within the sintered glass body 1 in precisely the same way as in the preceding figures. In contrast to the preceding figures, the ends 3 of the power supply lines 2 are designed to be long and sprung, however. If such a stopper 10 is pushed or screwed into a discharge vessel end as in FIG. 2, the ends of the power supply lines 2 attach themselves along the circumference of the stopper into the intermediate space between the sintered glass body 1 and the wall of the discharge vessel 6. In the overlap, the power supply lines 2 can then make contact over a large area with the inner electrodes 7 with their sprung ends 3. The alignment of the stopper in this case does not need to be set precisely since the ends 3 of the power supply lines 2 have a certain length.

FIG. 7b also shows a stopper 10 with a sintered glass body as in FIG. 1. The power supply lines 2 are designed at the end and within the sintered glass body in precisely the same way as in FIG. 7a. Precisely as in FIG. 7a, the ends 3 of the power supply lines 2 are designed to be long and sprung. However, in contrast to FIG. 7a, the ends 3 have a different orientation. If the stopper 10 shown in FIG. 7b is pushed into a discharge vessel end as in FIG. 2, the ends of the power supply lines 2 attach themselves along the insertion direction of the stopper into the intermediate space between the sintered glass body 1 and the wall of the discharge vessel 6. In this case, too, it is the case that the power supply lines 2 can make contact over a large area with the inner electrodes 7 with their sprung ends 3 in the overlap.

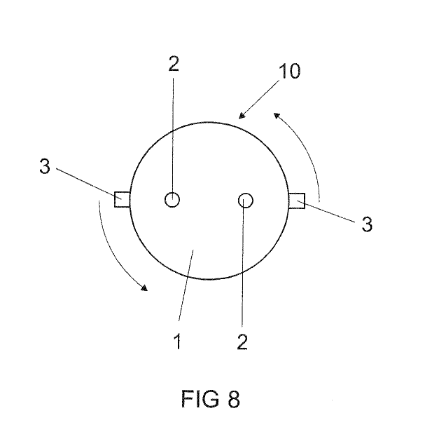

FIG. 8 shows power supply lines 2, in which the ends 3 are designed to be short, robust and sharp-edged. The corresponding stopper 10 is screwed into a discharge vessel end as in FIG. 2, the ends 3 of the power supply lines 2 cutting into the electrode 7 in the overlap 9.

On the left-hand side, FIG. 9 shows the stopper 10 from FIG. 1, introduced into a tubular discharge vessel 72, the discharge vessel 72 not yet having been sealed in a gas-tight manner by the stopper 10. A cylindrical sintered glass cork 71 without power supply lines is introduced into the right-hand end of the discharge vessel 72. In this case, too, the discharge vessel 72 has not yet been connected in a gas-tight manner to the cork 71. In each case one annular gas-permeable gap is located between the stopper 10 and the wall of the discharge vessel 72 or between the cork 71 and the discharge vessel wall 72. The discharge vessel 72 can first be rinsed through this gap in order to then be filled with the discharge medium. If the discharge vessel 72 has been filled with the discharge medium, the wall of the discharge vessel 72 is heated and attached to the stopper 10 or the cork 71, with the result that the respective annular gas-permeable gap is then sealed in a gas-tight manner.

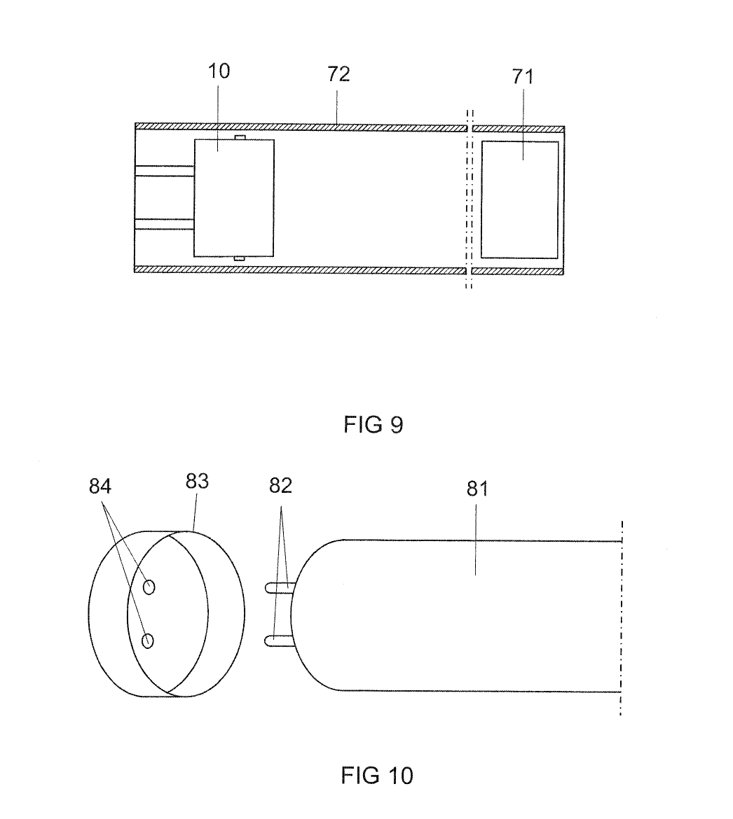

FIG. 10 shows a discharge lamp 81 according to the invention having power supply lines 82 in the form of plug-type contacts which emerge from it. FIG. 10 shows, on the left-hand side, a lampholder 83 which fits this discharge lamp 81, with receptacles 84 for the power supply lines 82. During operation, the receptacles 84 accommodate the power supply lines 82 and therefore make it possible to make contact between the electrodes of the discharge lamp and a power source (not shown). In this case, the periphery of the lampholder 84 grips the discharge vessel of the discharge lamp 81, and the receptacles 84 support the power supply lines 82.

1. A dielectric barrier discharge lamp (81) with a discharge vessel (6, 72) having inner electrodes (7) and having a gas-impermeable stopper (10), which stopper (10) has power supply lines (2) making contact with the inner electrodes (7),
characterized in that the gas-impermeable stopper (10) with the power supply lines (2) is incorporated in the discharge vessel (6, 72) as a cohesively handleable part, by the stopper (10) being introduced into an opening of the discharge vessel (6, 72), and
the opening being sealed in a gas-tight manner by the stopper (10) owing to a change in shape of at least one of the discharge vessel (6, 72) and the stopper (10).

2. The dielectric barrier discharge lamp (81) as claimed in claim 1, in which the introduced stopper (10) overlaps the inner electrodes (7), and the power supply lines (2) run through the stopper (10), said power supply lines (2) emerging from the stopper (10) in the overlap (9) and making contact with the electrodes (7).

3. The dielectric barrier discharge lamp (81) as claimed in claim 1, in which part of one of the power supply lines (2) is in electrically conductive contact with the discharge medium enclosed in the discharge lamp (81).

4. The dielectric barrier discharge lamp (81) as claimed in claim 1, in which the stopper (10) has an additional auxiliary ignition electrode (42, 43), which is in contact with the discharge medium enclosed in the discharge lamp (81).

5. The dielectric barrier discharge lamp (81) as claimed in claim 1, in which the gas-impermeable stopper (10) has a sintered glass part (1).

6. The dielectric barrier discharge lamp (81) as claimed in claim 1, in which the discharge vessel wall (6) is attached in a gas-tight manner to the stopper (10) by means of heating.

7. The dielectric barrier discharge lamp (81) as claimed in claim 2, in which the power supply lines (2) emerge in a sprung manner from the stopper (10) with their ends (3) which are provided for making contact with the electrodes (7), with the result that they attach themselves to the electrodes (7) in the overlap (9).

8. The dielectric barrier discharge lamp (81) as claimed in claim 2, in which the power supply lines (2) emerge from the stopper (10) with their ends (3) which are provided for making contact with the electrodes, with the result that they are anchored in the electrodes (7) by means of being rotated.

9. The dielectric barrier discharge lamp (81) as claimed in claim 1, in which the stopper (10) is introduced into the opening of the discharge vessel (6, 72) in such a way that a previously gas-permeable gap between the stopper (10) and the discharge vessel wall (6) is sealed in a gas-tight manner, the discharge vessel (6, 72) previously having been filled with the discharge medium through this gap.

10. A system comprising a dielectric barrier discharge lamp (81) as claimed in claim 1 and a lampholder, the discharge lamp and the lampholder (83) being matched to one another in such a way that the lampholder (83) connects the power supply lines (2) of the stopper (10) to a power source, the power supply lines (2) then being guided into the lamp holder (83) supported merely by the stopper (10).

11. The system as claimed in claim 10, in which the lampholder (83), for the purpose of holding the discharge lamp (81), directly grips at least one of the discharge vessel (6, 72) and the stopper (10).

12. A method for manufacturing a dielectric barrier discharge lamp (81), which has a discharge vessel (6, 72) having inner electrodes (7) and having a gas-impermeable stopper (10), which stopper (10) has power supply lines (2) making contact with the inner electrodes (7), having the following steps:
manufacturing the gas-impermeable stopper (10) with its power supply lines (2) as a cohesively handleable part,
introducing the stopper (10) into an opening of the discharge vessel (6, 72), and
sealing the opening in a gas-tight manner by the stopper (10) owing to a change in shape of at least one of the discharge vessel (6, 72) and the stopper (10).

13. The method as claimed in claim 12, in which the introduced stopper (10) overlaps the inner electrodes (7), and the power supply lines (2) run through the stopper (10), said power supply lines emerging from the stopper (10) in the overlap (9) and making contact with the electrodes (7).

14. The method as claimed in claim 12, in which, after sealing, part of one of the power supply lines (2) is in electrically conductive contact with the discharge medium.

15. The method as claimed in claim 12, in which the stopper (10) has an additional auxiliary ignition electrode (42, 43), which is in contact with the discharge medium after sealing.

16. The method as claimed in claim 12, in which the gas-impermeable stopper (10) has a sintered glass part (1).

17. The method as claimed in claim 12, in which, for the gas-tight sealing, the discharge vessel wall (6) is heated and attached to the stopper (10).

18. The method as claimed in claim 13, in which the power supply lines (2) emerge in a sprung manner from the stopper (10) with their ends (3) which are provided for making contact with the electrodes (7) before the introduction, the sprung ends (3) of the power supply lines (2) attaching themselves to the electrodes (7) in the overlap (9) during the introduction.

19. The method as claimed in claim 13, in which the power supply lines (2) emerge from the stopper (10) with their ends (3) which are provided for making contact with the electrodes (7) before the introduction, then, during the introduction, these ends (3) of the power supply lines (2) being anchored in the electrodes (7) by means of being rotated.

20. The method as claimed in claim 12, in which the stopper (10) is introduced into the opening in such a way that a gas-permeable gap is located between the stopper (10) and the discharge vessel wall (6),
having the further step of:
filling the discharge vessel (6, 72) with the discharge medium through the gap, the opening then being sealed in a gas-tight manner after the filling.

21. A method for operating a dielectric barrier discharge lamp (81) manufactured as claimed in claim 12 having the step of:
introducing the discharge lamp (81) into a lamp holder (83), which connects the power supply lines (2) of the stopper (10) to a power source, the power supply lines (2) being guided into the lamp holder (83) supported merely by the stopper (10).

22. The method as claimed in claim 21, in which the lamp holder (83), for the purpose of holding the discharge lamp (81), directly grips at least one of the discharge vessel (6, 72) and the stopper (10).
